(19) United States
(12) Patent Application Publication
(10) Pub. No.: US 2023/0394965 A1
(43) Pub. Date: Dec. 7, 2023

(54) Traffic Signal Smooth Leading Control Method

(71) Applicant: Weiping Meng, Flushing, NY (US)

(72) Inventor: Weiping Meng, Flushing, NY (US)

(21) Appl. No.: 18/248,703

(22) PCT Filed: Oct. 12, 2020
(86) PCT No.: PCT/CN2020/000240

§ 371 Date: Apr. 12, 2023

(51) Int. Cl. G08G 1/082

(52) U.S. Cl. CPC G08G 1/082

(57) ABSTRACT

A traffic signal lead green-wave optimization control method, concerns traffic signal control, main steps includes: 1) determine lead direction and lead road channel; 2) determine lead reference intersection and phase; 3) compute smooth lead intersection phase offset. Advantage: subtracting safety brake-to-stop time from intersection lead green wave phase offsets makes that vehicles led obtain green lights turn-on in advance before stop-lines of front intersections in the green-wave lead road channels, smoothly drive pass front intersections, avoiding vehicles' driving fluctuation of brake, speed-down, stop at stop-line, lessens vehicle intersection pass time, improves efficiency of traffic.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### Technical Field and Prior Art

The present invention relates generally to a method for traffic signal mode control, particularly to traffic signal lead control method making vehicle driving smoothly.

Currently traffic signal leading technology includes: coordination, that's line-coordination, i.e. green-wave, and line-coordination-based area control. The intersection absolute phase offset of these leading technologies are all based on time that are green-wave channel distance between intersection and green-wave source intersection divided by set-vehicle-speed; which may lead vehicles consecutively obtain green light when the vehicles drive at stop line of vehicle's front intersection with no staying at red light, meanwhile, these led vehicles must make speed fluctuation of speed-down and brake-to-stop at stop line before green light turn-on of the front intersection. Eliminating these speed fluctuation f speed-down and brake-stop may improve efficiency of traffic further.

### BRIEF SUMMARY OF THE INVENTION

It is an object of the present invention to eliminate vehicle's speed fluctuation of speed-down and brake-stop at stop line before green light turn-on of the front intersection in lead green-wave channels.

In keeping with the object, the scheme for eliminating vehicle's speed fluctuation of speed-down and brake-stop at stop line before the front intersection green light turns on in a lead green-wave channel is proposed, the features of the present invention is as follow:

A traffic signal smooth leading control method includes steps of:
S1, compute special intersection's lead green-wave phase offset, said intersection lead green-wave phase offset means time-offset of a ratio-signal phase of an intersection with ratio-signal mode in a lead green-wave channel related to reference intersection phase, the time offset is lead green-wave absolute phase offset: 1) determine lead direction and lead road channel; 2) determine lead green-wave reference intersection and phase, by setting an intersection and phase of said road channel; 3) compute the special intersection lead green-wave phase offset: let said lead green-wave absolute phase offset of an intersection in said road channel subtract safe brake-to-stop time Tb that a vehicle driving at set-speed brakes to stop at stop line, which obtains the special intersection's lead green-wave phase offset, that's linear smooth lead green-wave intersection phase offset, one of kinds of smooth leading intersection phase offset;
S2, configure interim period of smooth leading green-wave of every intersection, 1) compute interim period time length: let remainder r of said smooth leading green-wave intersection phase offset divided by signal period as interim period time length; 2) make signals of the interim period: let sum of signals time tm of lead direction and signals time ts of another direction crossing lead direction of said interim period equals to said interim period length r, that's, r=tm+ts, and configure corresponding signals, that is interim period of an intersection;
S3, each intersection runs out its interim period first, then run its next ratio-signal period;

Another feature of the present traffic signal smooth leading control method is that special intersection's leading green-wave phase offset computation includes:
(1), set ratio-signal mode to every intersection of said green-wave road channel; (2), compute intersection lead green-wave phase offset: equals to sum of drive-times of all road-segments between the above set reference intersection and an intersection in the above set road channel, also means phase offset of a downstream intersection of the lead direction is increased by one intersection relative phase offset tv comparing to the adjacent upstream one of the downstream one, said drive-time tv of a road-segment equals to quotient of the road-segment length d divided by set-speed v0 of the road-segment, that's tv=d/v0; (3), let said intersection lead green-wave phase offset subtract safe brake-to-stop time Tb that a vehicle driving at set-speed brakes to stop at stop line, which obtains the special intersection's leading green-wave phase offset, that's linear smooth leading green-wave intersection phase offset, one of kinds of smooth leading intersection phase offset; said safe brake-to-stop time Tb is the time when a vehicle running at set-speed and at an appropriate position db brakes just to stop at stop line of the vehicle front intersection;

Another feature of the present traffic signal smooth leading control method is that special intersection's leading green-wave phase offset computation includes:
1) determine lead direction and lead road channel, by setting a direction in an area as first lead direction and another direction as second lead direction, road channels in subareas of said first lead direction and road channels in subareas of said second lead direction cross getting intersections, which may include virtual intersections and virtual connecting road-segments;
2) determine lead green-wave reference intersection and phase, by setting one of the intersections as a related intersection, and setting a lead direction's phase of the related intersection as lead green-wave reference intersection phase; based on green light turn-on time and set phases' time ratios of the lead green-wave reference intersection phase, set second-reference phase for green lights turn-on time of another direction′ subareas, and or further set downstream intersections' phases of the reference intersection phase as second-reference intersection phases; the reference intersection phase may be any intersection and its phase in principle, is determined on practical situation, may be a corner intersection of an area including virtual intersections as reference intersection phase;
3) compute the special intersection leading green-wave phase offset: compute areal smooth lead green-wave intersection phase offsets of all intersections in an area: based on the set lead green-wave reference intersection and its phase and second-reference intersection phases, and their related linear smooth leading green-wave intersection phase offsets of intersections in the set lead road channels, that are between the intersections and reference intersection or second-reference intersection phases in the area, compute green light turn-on times of remaining smooth lead intersection phases, which obtains intersection smooth lead green wave phase offsets of remaining intersections in the area;

Another feature of the present traffic signal smooth leading control method is that special intersection's leading green-wave phase offset computation includes:
(1), compute intersection lead green-wave phase offsets of downstream intersections in the lead road channel corresponding to and based on one of said reference intersection phase and said second-reference intersection phase;
(2), compute intersection linear smooth lead green-wave phase offsets of the intersections based on one of said reference intersection phase and said second-reference intersection phase: let the intersection lead green-wave phase offsets subtract safe brake-to-stop time Tb;
(3), compute intersection leading green-wave phase offsets of downstream intersections in the lead road channel corresponding to and based on the other one of said reference intersection phase and said second-reference intersection phase;
(4), compute intersection linear smooth lead green-wave phase offsets of the intersections based on the other one of said reference intersection phase and said second-reference intersection phase: let the intersection lead green-wave phase offset subtract safe brake-to-stop time Tb, which obtains the other linear smooth lead green-wave intersection phase offset of the other direction phase, so, obtain areal smooth lead green-wave intersection phase offsets of the area;

Another feature of the present traffic signal smooth leading control method is that the interim period configuration of smooth leading green-wave of every intersection includes:
for shorter interim period time, directly extend red or green light time of current signal period by the interim period time, fulfilling the interim period; for interim period time near one signal period, directly shorten red or green light time of current period by complement value of the interim period time, that's shortening red light or green light time of current signal period, fulfilling the interim period;

The advantages of the present invention are below: subtracting safety brake-to-stop time from intersection lead green wave phase offsets makes that vehicles led obtain green lights turn-on in advance before stop-lines of front intersections in the green-wave lead road channels, smoothly drive pass front intersections, avoiding vehicles' driving fluctuation of brake, speed-down, stop at stop-line, lessens vehicle intersection pass time, improves efficiency of traffic.

### BRIEF DESCRIPTION OF THE DRAWINGS

FIG. 1 is a timing-distance diagram of a linear smooth lead green-wave, including FIG. 1-a of a road channel sketch of a linear smooth lead green-wave, FIG. 1-b of time-distance sketch of the linear smooth lead green-wave;

FIG. 2 is road channels sketch of an areal smooth lead green-wave;

FIG. 3 is a flowchart of a linear smooth lead green-wave control method;

FIG. 4 is a flowchart of an areal smooth lead green-wave control method;

### LIST OF REFERENCE NUMERAL UTILIZED IN THE DRAWING

### Detailed Description of the Invention

### Description of the Preferred Embodiments, Industry Applications

Detailed description of two embodiments of the invention smooth lead green-wave in conjunction with the accompanying drawings:

Embodiment 1, as shown a linear smooth lead green-wave signals in FIG. 1, including FIG. 1-a and FIG. 1-b; FIG. 1-a shows a linear smooth lead green-wave road channel with 6 intersections, I-1 to I-5, one of them, I-6, is reference intersection with reference phase straight west, which leads west-heading vehicles labeled by black arrow, adjacent-intersections-between road-segments labeled by #/#, meaning road-segment length(meter)/set-drive-time(second) of set-speed of 45 km/h, for an example, 375/30 is for road-segment length 375 meter/set-drive-time 30 second; FIG. 1-b shows timing-distance sketch of the above linear smooth lead green-wave road channel, where there are 6 groups of short thick vertical dotted solid lines, that solid lines are for vehicles' positions when straight phase green lights of smooth lead green-wave turn on of intersections corresponding below the solid lines, that's smooth lead green-wave phase offset and their green light turn-on time, at the lower ends of these lines there are two horizontal dotted lines, thin dotted lines are for lead green-wave phase offsets, thick dotted lines for smooth lead green-wave phase offsets, the interval of the two line for brake-time Tb, 3 seconds or so, of vehicles running at set-speed of 45 km/h, the other group of vertical dotted lines for the stop-line positions when green lights of lead green-wave turn on, the spacing db of the two vertical dotted solid lines, 20 meters or so, for brake-distance over said brake-time Tb at set-speed; FIG. 1 shows straight phase green light turn-on time of each intersection and position db when a vehicle needs brake-time Tb before each intersection, avoiding vehicle speed fluctuation of brake, speed-down, stop; (These icons and explanation apply to all drawings below);

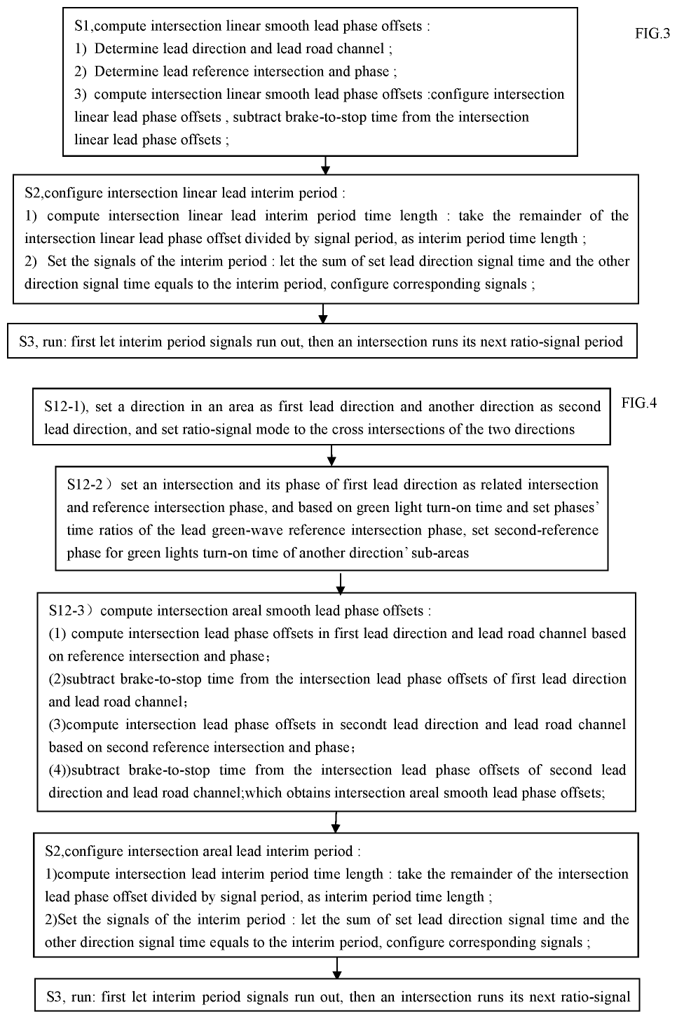

FIG. 3 shows the configuration and control method of linear smooth lead green-wave.
S1, compute special intersection's lead green-wave phase offset: 1) determine lead direction and lead road channel: set West as lead direction, that's straight phase signals controlling west-heading traffic of intersections, road channel with intersections I-1, I-2, I-3, I-4, I-5, and I-6 as lead road channel; 2) determine lead green-wave reference intersection and phase, by setting intersection I-6 and its straight phase west direction as the reference intersection and phase; Also, other intersections of the road channel may be as, such as I-5, then compute corresponding phase offsets; 3) compute the special intersection leading green-wave phase offset: (1), set ratio-signal mode to every intersection of the green-wave road channel: set ratio-signal to every intersection of the green-wave road channel with same signal period and no time-offset, signal period 90 seconds, each direction phase time 45 seconds, each straight-left/right turn phase time ratio 2:1, straight phase time 30 seconds, left/right turn phase time 15 seconds; (2), compute intersection lead green-wave phase offset: based on the above set reference intersection and phase, each downstream intersection's straight phase of the above set lead direction is configured as one more intersection relative phase offset than its directly adjacent upstream intersection, the intersection relative phase offset is determined by the directly upstream road-segment of the downstream one, and equals to the time tv that a vehicle at set-speed v0=12.5 meter/second(45 km/h) drives whole the road-segment length d, that's tv=d/v0, which obtains lead green-wave phase offsets of the above set road-channel with 6 intersections: 141, 111, 85, 58, 30, 0; (3) let the intersection lead green-wave phase offset based on the above set reference intersection phase subtract safe brake-to-stop time Tb of 3 seconds, corresponding brake-distance db of 20 meters, which obtains the special intersection's leading green-wave phase offsets, i.e., the linear smooth leading green-wave intersections' phase offsets, of the above set lead road-channel with 6 intersections: 141-3, 111-3, 85-3, 58-3, 30-3, 0;
S2, configure interim period of smooth leading green-wave of every intersection: 1) compute interim period time length of the linear smooth leading green-wave intersection: let remainder r of the linear smooth leading green-wave intersection phase offset divided by signal period as interim period time length, that's 48, 18, 82, 55, 27, 0; 2) make signals of the interim period: let sum of signals time tm of lead direction and signals time ts of the direction crossing the lead direction of the interim period equals to the interim period time r, that's, r=tm+ts, and configure corresponding signals for tm and ts, which obtains interim periods of the intersections: 24+24, 9+9, 41+41, 28+27, 14+13, 0;
S3, each intersection runs out its interim period first, then run its next ratio-signal period: when current signal period of each intersection finishes, the interim period is run first, interim-period timer count by second: if interim-period timer count is smaller than the set interim period, the intersection displays interim period signals, and increase the timer by one second, otherwise, the intersection runs its next signal period;

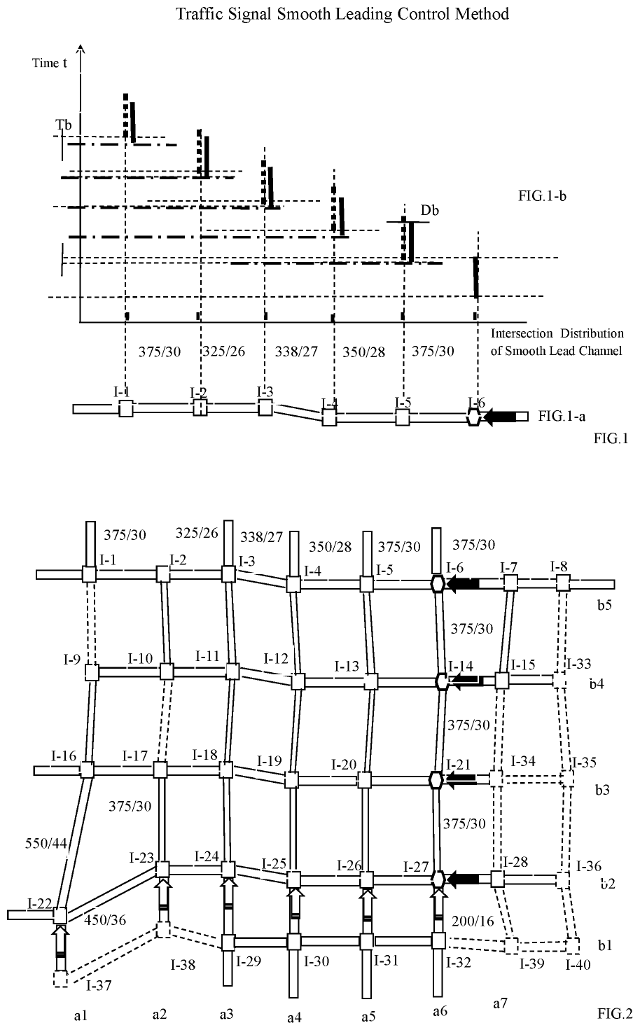

Embodiment 2, as shown an areal smooth lead green-wave signals in FIG. 2;

The configuration and control method of an areal smooth lead green-wave is as FIG. 4.
S12, compute special intersection's lead green-wave phase offset:
   1) determine lead direction and lead road channel, set North as the first lead direction and set West as second lead direction, the set first lead direction covers 7 sub-areas, a1, a2, a3, a4, a5, a6, a7, and the set second lead direction covers 5 sub-areas, b1, b2, b3, b4, b5, they cross getting 32 intersections, that's intersections I-1 to I-32, including virtual intersections, denoted by dotted line squares and I-33 to I-40, which are connected with virtual road-segments, and set ratio-signal mode to these intersections;
   2) determine lead green-wave reference intersection and phase, set one of the 32 intersections, intersection I-27, as a related intersection, and set the North direction's straight phase of the related intersection as lead green-wave reference intersection phase, which lead north-heading vehicle flows in 5 road-channels, from I-23, I-24, I-25, I-26, and I-27; based on green light turn-on time and set phases' time ratios of the intersections, set the other lead direction straight phase green light turn-on time of the other sub-areas of the related intersection as second-reference direction phase green light turn-on time, and further set the reference intersection's downstream intersections' phases as second-reference intersection phases, that's, the downstream intersections of North lead direction are I-21, I-14, I-6 in order from the near to the far from the reference intersection, controlling west signals of these intersections that lead west-heading vehicles flows in 4 road-channels, I-27, I-21, I-14, I-6, labeled by thick arrow; the reference intersection phase may be any intersection and its phase in principle, is determined on practical situation, may be a corner intersection of an area including virtual intersections as reference intersection phase, for example, set I-40 may be set as reference intersection and phases, compute corresponding phase offsets;
   3) compute the special intersection leading green-wave phase offset: compute areal smooth lead green-wave intersection phase offsets of all intersections in an area: based on the set lead green-wave reference intersection and its phase and second-reference intersection phases, and their related linear smooth leading green-wave intersection phase offsets of intersections in the set lead road channels, that are between the intersections and reference intersection or second-reference intersection phases in the area, compute green light turn-on times of remaining smooth lead intersection phases, which obtains intersection special lead green wave phase offsets of remaining intersections in the area, that's, intersection smooth lead green wave phase offsets of remaining intersections in the area; computation is as follows:
(1), compute lead green-wave phase offsets of every downstream intersection of set lead direction in set lead road channel based on set reference intersection phase: intersections I-27, I-21, I-14, I-6 phase offsets of North road-channels of the reference intersection: 0, 30, 60, 90;
(2), compute intersection lead green-wave phase offsets of the downstream intersections of set lead direction in set lead road channel based on set second reference West direction phase of the second reference intersections I-27, I-21, I-14, I-6, corresponding data of intersection and its phase offset are denoted by (*,*), as below:
(I-1,231), (I-2,201), (I-3,175), (I-4,148), (I-5,120), (I-6,90), (I-7,60), (I-8,30);
(I-9,201), (I-10,171), (I-11,145), (I-12,118), (I-13,90), (I-14,60), (I-15,30);
(I-16,171), (I-17,141), (I-18,115), (I-19,88), (I-20,60), (I-21,30);
(I-22,147), (I-23,111), (I-24,85), (I-25,58), (I-26,30), (I-27,0);
   (I-29,69), (I-30,42), (I-31,14), (I-32,-16);
(3), compute intersection linear smooth lead green-wave phase offsets of every downstream intersection of North lead road channels based on set reference intersection phase: let intersections I-27, I-21, I-14, I-6 phase offsets of North-lead road-channels of the reference intersection: 0, 30, 60, 90, subtract safe brake-to-stop time Tb of 3, obtain smooth lead green-wave intersection phase offsets of the lead road-channel, 0, 27, 57, 87;
(4), compute intersection areal smooth lead green-wave phase offsets of every downstream intersection of West lead road-channels based on the second reference intersections, I-27, I-21, I-14, I-6, and their second reference phases, the data groups of downstream intersection and its phase offset are denoted by (*,*), as below:
   (I-1,225), (I-2,195), (I-3,169), (I-4,142), (I-5,114), (I-6,87);
   (I-9,195), (I-10,165), (I-11,139), (I-12,112), (I-13,84), (I-14,57);
   (I-16,165), (I-17,135), (I-18,109), (I-19,82), (I-20,54), (I-21,27);
   (I-22,144), (I-23,108), (I-24,82), (I-25,55), (I-26,27), (I-27,0);

Where 7 upstream intersections, I-7, I-8, I-15, I-29 to I-32, are not set smooth lead green-wave, keep lead green-wave phase offsets; also, they may be set as another embodiment;
S2, configure interim period of smooth lead green-wave of every intersection, make interim period of an intersection using the intersection's areal smooth lead green-wave phase offset:
   1) compute interim period time length: let remainder r of said smooth leading green-wave intersection phase offset divided by signal period as interim time length, that's as below:
      (I-1,35), (I-2,15), (I-3,79), (I-4,52), (I-5,24), (I-6,87);
      (I-9,15), (I-10,75), (I-11,49), (I-12,22), (I-13,84), (I-14,57);
      (I-16,75), (I-17,45), (I-18,19), (I-19,82), (I-20,54), (I-21,27);
      (I-22,54), (I-23,18), (I-24,82), (I-25,55), (I-26,27), (I-27,0);
   2) make signals of the interim periods: let sum of signals time tm of lead direction and signals time ts of second lead direction equals to the above interim time r, that's, r=tm+ts, and configure corresponding signals, obtain interim period with signals the intersections as below:
(I-1,18+17), (I-2,15), (I-3,40+39), (I-4,26+26), (I-5,12+12), (I-6,44+43);
(I-9,15), (I-10,38+37), (I-11,25+24), (I-12,11+11), (I-13,42+42), (I-14,29+28);
(I-16,38+37), (I-17,23+22), (I-18,10+9), (I-19,41+41), (I-20,27+27), (I-21,14+13);
(I-22,27+27), (I-23,9+9), (I-24,41+41), (I-25,28+27), (I-26,14+13), (I-27,0)

Where (I-2,15), (I-9,15) are two intersections with short interim period time, that are shorter than 16, not fit for interim period with green lights, may be made by extending current signal period's red signal for the interim period time, fulfilling the interim period; meanwhile, (I-3,79), (I-6,87), (I-10,75), (I-13,84), (I-16,75), (I-19,82), (I-24,82)'s interim periods may be made by shortening current signal periods, fulfilling the interim period;
S3, each intersection runs out its interim period first, then run next its ratio-signal period: when current signal period of each intersection finishes, the interim period run first, interim-period countdown-timer count by second: if the timer count is bigger than 0, intersection displays interim period signals, and decrease the timer by one second, otherwise, intersection runs its next signal period.

What is claimed as new and desired to be protected by Letters Patent is set forth in the following:

1. A method of controlling road-net traffic signals includes the steps of:
S1, compute special intersection's lead green-wave phase offset, said intersection lead green-wave phase offset means time-offset of a ratio-signal phase of an intersection with ratio-signal mode in a lead green-wave channel related to reference intersection phase, the time offset is lead green-wave absolute phase offset: 1) determine lead direction and lead road channel; 2) determine lead green-wave reference intersection and phase, by setting an intersection and phase of said road channel; 3) compute the special intersection lead green-wave phase offset: let said lead green-wave absolute phase offset of an intersection in said road channel subtract safe brake-to-stop time Tb that a vehicle driving at set-speed brakes to stop at stop line, which obtains the special intersection's lead green-wave phase offset, that's linear smooth lead green-wave intersection phase offset, one of kinds of smooth leading intersection phase offset;
S2, configure interim period of smooth leading green-wave of every intersection, 1) compute interim period time length: let remainder r of said smooth leading green-wave intersection phase offset divided by signal period as interim period time length; 2) make signals of the interim period: let sum of signals time tm of lead direction and signals time ts of another direction crossing lead direction of said interim period equals to said interim period length r, that's, r=tm+ts, and configure corresponding signals, that is interim period of an intersection;
S3, each intersection runs out its interim period first, then run its next ratio-signal period.

2. A method of controlling road-net traffic signals as in claim 1, wherein the special intersection's leading green-wave phase offset computation includes the steps:
(1), set ratio-signal mode to every intersection of said green-wave road channel; (2), compute intersection lead green-wave phase offset: equals to sum of drive-times of all road-segments between the above set reference intersection and an intersection in the above set road channel, also means phase offset of a downstream intersection of the lead direction is increased by one intersection relative phase offset tv comparing to the adjacent upstream one of the downstream one, said drive-time tv of a road-segment equals to quotient of the road-segment length d divided by set-speed v0 of the road-segment, that's tv=d/v0; (3), let said intersection lead green-wave phase offset subtract safe brake-to-stop time Tb that a vehicle driving at set-speed brakes to stop at stop line, which obtains the special intersection's leading green-wave phase offset, that's linear smooth leading green-wave intersection phase offset, one of kinds of smooth leading intersection phase offset; said safe brake-to-stop time Tb is the time when a vehicle running at set-speed and at an appropriate position db brakes just to stop at stop line of the vehicle front intersection.

3. A method controlling road-net traffic signals as in claim 1, wherein the special intersection's leading green-wave phase offset computation includes the steps:
1) determine lead direction and lead road channel, by setting a direction in an area as first lead direction and another direction as second lead direction, road channels in subareas of said first lead direction and road channels in subareas of said second lead direction cross getting intersections, which may include virtual intersections and virtual connecting road-segments;
2) determine lead green-wave reference intersection and phase, by setting one of the intersections as a related intersection, and setting a lead direction's phase of the related intersection as lead green-wave reference intersection phase; based on green light turn-on time and set phases' time ratios of the lead green-wave reference intersection phase, set second-reference phase for green lights turn-on time of another direction′ subareas, and or further set downstream intersections' phases of the reference intersection phase as second-reference intersection phases; the reference intersection phase may be any intersection and its phase in principle, is determined on practical situation, may be a corner intersection of an area including virtual intersections as reference intersection phase;
3) compute the special intersection leading green-wave phase offset: compute areal smooth lead green-wave intersection phase offsets of all intersections in an area: based on the set lead green-wave reference intersection and its phase and second-reference intersection phases, and their related linear smooth leading green-wave intersection phase offsets of intersections in the set lead road channels, that are between the intersections and reference intersection or second-reference intersection phases in the area, compute green light turn-on times of remaining smooth lead intersection phases, which obtains intersection smooth lead green wave phase offsets of remaining intersections in the area.

4. A method controlling road-net traffic signals as in claim 1, wherein the special intersection's leading green-wave phase offset computation includes the steps:
(1), compute intersection lead green-wave phase offsets of downstream intersections in the lead road channel corresponding to and based on one of said reference intersection phase and said second-reference intersection phase;
(2), compute intersection linear smooth lead green-wave phase offsets of the intersections based on one of said reference intersection phase and said second-reference intersection phase: let the intersection lead green-wave phase offsets subtract safe brake-to-stop time Tb;
(3), compute intersection leading green-wave phase offsets of downstream intersections in the lead road channel corresponding to and based on the other one of said reference intersection phase and said second-reference intersection phase;
(4), compute intersection linear smooth lead green-wave phase offsets of the intersections based on the other one of said reference intersection phase and said second-reference intersection phase: let the intersection lead green-wave phase offset subtract safe brake-to-stop time Tb, which obtains the other linear smooth lead green-wave intersection phase offset of the other direction phase, so, obtain areal smooth lead green-wave intersection phase offsets of the area.

5. A method controlling road-net traffic signals as in claim 1, wherein the interim period configuration of smooth leading green-wave of every intersection includes:
for shorter interim period time, directly extend red or green light time of current signal period by the interim period time, fulfilling the interim period; for interim period time near one signal period, directly shorten red or green light time of current period by complement value of the interim period time, that's shortening red light or green light time of current signal period, fulfilling the interim period.
